(19) United States
(12) Patent Application Publication
(10) Pub. No.: US 2022/0169034 A1
(43) Pub. Date: Jun. 2, 2022

(54) PROCESSING FLUID, METHOD OF PRODUCING PRINTED MATTER, AND DEVICE OF PRODUCING PRINTED MATTER

(71) Applicants: Hiroki HAGIWARA, Kanagawa (JP); Tomohiro Nakagawa, Kanagawa (JP); Sei Yamamoto, Tokyo (JP); Kazuhiko Umemura, Kanagawa (JP); Yuya Hirokawa, Kanagawa (JP); Takuya Saiga, Kanagawa (JP); Risa Tamura, Kanagawa (JP)

(72) Inventors: Hiroki HAGIWARA, Kanagawa (JP); Tomohiro Nakagawa, Kanagawa (JP); Sei Yamamoto, Tokyo (JP); Kazuhiko Umemura, Kanagawa (JP); Yuya Hirokawa, Kanagawa (JP); Takuya Saiga, Kanagawa (JP); Risa Tamura, Kanagawa (JP)

(73) Assignee: Ricoh Company, Ltd., Tokyo (JP)

(21) Appl. No.: 17/455,957

(22) Filed: Nov. 22, 2021

(30) Foreign Application Priority Data
Nov. 30, 2020 (JP) 2020-198660
Aug. 30, 2021 (JP) 2021-139528

(51) Int. Cl. B41J 2/21; B41J 11/00; C09D 11/322; C09D 11/38

(52) U.S. Cl. CPC B41J 2/2103; C09D 11/38; C09D 11/322; B41J 11/00216

(57) ABSTRACT

Provided is a processing fluid including nonionic acrylic resin particles, and a polyvalent metal salt. A volume average particle diameter of the nonionic acrylic resin particles is 100 nm or greater but 300 nm or less. A proportion of the nonionic acrylic resin particles in the processing fluid is greater than 2.0% by mass. An average reflectance of the processing fluid to light having a wavelength of 400 nm or greater but 700 nm or less is 70% or greater.

### CROSS-REFERENCE TO RELATED APPLICATIONS

This patent application is based on and claims priority pursuant to 35 U.S.C. § 119(a) to Japanese Patent Application No. 2020-198660 filed on Nov. 30, 2020 and Japanese Patent Application No. 2021-139528 filed on Aug. 30, 2021, in the Japan Patent Office, the entire disclosure of which is hereby incorporated by reference herein.

### BACKGROUND

### Technical Field

The present disclosure relates to a processing fluid, a method of producing printed matter, and a device of producing printed matter.

### Description of the Related Art

In recent years, a demand for an inkjet printer for digital printing capable of printing various designs with a small output volume without a printing plate has been increasing even in the field of commercial printing or industrial printing, which mainly uses analog printing such as offset printing or flexographic printing.

As main printed items in commercial printing, brochures, catalogs, posters, manuals, etc., are listed. As main printed items in industrial printing, labels, packages, textiles, cardboard boxes etc. are listed.

Particularly in the field of industrial printing, preferred are various designs with a small output volume, which facilitates salts of products.

When various printed matter with a small output volume is produced by digital printing as described above, various types of printing bases are used. However, surface characteristics vary depending on a printing base, which may affect a quality of resulting printed matter.

It has been known that a pre-processing fluid, which enhances receptivity of an ink, is applied before applying an ink in order to produce similar quality of printed matter with various bases.

Moreover, the pre-processing fluid is desired to have desirable discharge ability of the pre-processing fluid itself in order to improve, not only appearance of printed matter, but also abrasion resistance of an image, and to discharge the processing fluid by inkjet coating.

### SUMMARY

According to one aspect of the present disclosure, a processing fluid includes nonionic acrylic resin particles and a polyvalent metal salt. The nonionic acrylic resin particles has a volume average particle diameter of 100 nm or greater but 300 nm or less. A proportion of the nonionic acrylic resin particles in the peocerssing fluid is greater than 2.0% by mass. An average reflectance of the processing fluid to light having a wavelength of 400 nm or greater but 700 nm or less is 70% or greater.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a perspective view illustrating one example of a device of producing printed matter of the present disclosure;

FIG. 2 is a perspective view illustrating one example of a main tank in the device of producing printed matter of the present disclosure; and

FIG. 3 is a conceptual view illustrating one example of a device of producing printed matter using the processing fluid of the present disclosure.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

The present disclosure can provide a processing fluid, which excels in storage stability and discharge stability as well as improving abrasion resistance of an image and preventing bleeding.

### (Processing Fluid)

The processing fluid of the present disclosure includes nonionic acrylic resin particles and a polyvalent metal salt. The nonionic acrylic resin particles have a volume average particle diameter of 100 nm or greater but 300 nm or less. A proportion of the nonionic acrylic resin particles in the processing fluid is greater than 2.0% by mass. An average reflectance of the processing fluid to light having a wavelength of 400 nm or greater but 700 nm or less is 70% or greater. The processing fluid may further include a coloring material, water, and other components according to the necessity.

In the present disclosure, the “processing fluid” may be referred to as a “pre-processing fluid” when the processing fluid is used before image formation.

In the related art, there is the following problem. Abrasion resistance of an ink film is insufficient when a strong load is applied, and the image may be peeled from a base, or the image may be blurred. As a result, a sharp image cannot be obtained in some cases.

The inventors of the present invention have diligently conducted researches to solve the problem. As a result, the present inventors have found that a processing fluid can achieve improved abrasion resistance of an image and prevention of blurring, and has excellent storage stability and discharge stability, when the processing fluid includes nonionic acrylic resin particles and a polyvalent metal salt, where a volume average particle diameter of the acrylic resin particles is 100 nm or greater but 300 nm or less, a proportion of the acrylic resin particles is greater than 2.0% by mass, and an average reflectance of the processing fluid to light having a wavelength of 400 nm or greater but 700 nm or less is 70% or greater.

The “average reflectance” is calculated using a value obtained by measuring the processing fluid by means of a spectrophotometer (U-3900H, available from Hitachi High-Tech Science Corporation) in the following measuring conditions. Three measuring samples are prepared. The average value of the measurement values of the measuring samples is determined as the average reflectance.

### <Measuring Conditions>

Measuring mode: wavelength scan
Data mode: % R
Onset wavelength: 800 nm
Offset wavelength: 200 nm
Scanning speed: 300 nm/min
Sampling interval: 0.5 nm

### Slit: 2 nm

The reflectance of the reflected light when irradiated with light having wavelengths of 400 nm or greater but 700 nm or less is measured.

Abrasion resistance of an ink film can be improved by applying the processing fluid of the present disclosure to the base before applying the ink. This is because the processing fluid has an effect of enhancing the adhesion between the base and the ink film and leveling the surface of the ink film, as the processing fluid includes acrylic resin particles having a volume average particle diameter of 100 nm or greater but 300 nm or less. Moreover, the processing fluid includes the acrylic resin particles in an amount of greater than 2% by mass considering adhesion with the base.

Since the processing fluid includes the polyvalent metal salt, the coloring material (e.g., pigment) included in the ink gets aggregated at the same time as the landing of the ink droplets, and therefore a sharp image can be obtained without bleeding between different colors (i.e., prevention of blur image).

When the processing fluid applied in advance is opaque or colored, the color of the processing fluid may affect a color tone of an image formed with the ink film. Therefore, the processing fluid is desired to be transparent. From this point of view, the processing fluid does not impart opacity or cloudiness and an image having excellent coloring can be obtained when the average reflectance of the processing fluid to light having a wavelength of 400 nm or greater but 700 nm or less is 70% or greater. Moreover, the average reflectance of the processing fluid being 70% or greater means that smoothness of surfaces of particles included in the processing fluid is high. When the average reflectance is 70% or greater, an effect of leveling a surface of an ink film to be formed is high, and abrasion resistance can be improved.

Since the acrylic resin particles in the processing fluid are not typically-used charge repulsion resin particles, but nonionic resin particles that are dispersed owing to steric repulsion, storage stability is secured. The inventors of the present invention have found from their researches that anionic resin particles, among charge repulsion resin particles, get immediately aggregated as mixed with a polyvalent metal salt. The inventors have found that, in case of cationic resin particles, storage stability of a processing fluid is sufficiently secured as being stored at room temperature, but the processing fluid is thickened when the processing fluid is left to stand at an elevated temperature during an accelerated test for simulating storage stability over an extended period of time.

The average reflectance is 70% or greater, preferably 80% or greater but 100% or less, and more preferably 90% or greater but 100% or less. When the average reflectance is 90% or greater but 100% or less, a vivid image without dullness can be obtained.

### <Nonionic Acrylic Resin Particles>

In the present disclosure, the nonionic resin particles are resin particles that can be dispersed owing to steric repulsion without using charges from neutralization of acidic or basic functional groups.

Specifically, the nonionic resin particles are resin particles from which a monomer including an acidic functional group (e.g., a carboxyl group and a sulfo group) or a basic functional group (e.g., an amino group) is not detected, when solids thereof are separated from a fluid composition by centrifugation, followed by measuring by means of pyrolysis GC-MS (e.g., GC-17A, available from Shimadzu Corporation).

The nonionic acrylic resin particles for use in the present disclosure are not particularly limited as long as the nonionic acrylic resin particles include a polymer of acrylic acid ester or methacrylic acid ester in the chemical structure thereof. Examples thereof include, but are not limited to, nonionic acrylic resin particles including a homopolymer of acrylic acid ester or methacrylic acid ester, and nonionic acrylic resin particles including a copolymer (e.g., a block copolymer, and a random copolymer) of acrylic acid ester or methacrylic acid ester.

Examples of the homopolymer include, but are not limited to, acrylic resin particles.

Examples of the copolymer include, but are not limited to, styrene-acrylic resin particles, vinyl acetate-acrylic resin particles, silicone-acrylic resin particles, and urethane-acrylic resin particles.

The volume average particle diameter of the nonionic acrylic resin particles is 100 nm or greater but 300 nm or less, preferably 100 nm or greater but 250 nm or less, more preferably 100 nm or greater but 200 nm or less, and even more preferably 100 nm or greater but 170 nm or less. When the volume average particle diameter of the nonionic acrylic resin particles is 100 nm or greater but 170 nm or less, abrasion resistance can be further improved.

The volume average particle diameter of the nonionic acrylic resin particles can be measured, for example, by means of a particle size analyzer (Nanotrac Wave-UT151, available from MicrotracBEL Corp.).

A proportion of the nonionic acrylic resin particles in the processing fluid is greater than 2% by mass, preferably greater than 2% by mass but less than 15% by mass, more preferably 3% by mass or greater but 10% by mass or less, and even more preferably 5% by mass or greater but 8% by mass or less. When the proportion of the nonionic acrylic resin particles is 3% by mass or greater but 10% by mass or less, abrasion resistance can be improved.

The nonionic acrylic resin particles may be appropriately synthesized for use, or may be selected from commercial products. Examples of the commercial products include, but are not limited to, VINYLAN 1225, VINYLAN 1245L, VINYLAN SS1008, VINYLAN 2684, and VINYLAN 2685 (all available from Nissin Chemical Industry Co., Ltd.), and AQ4790 (available from DAICEL MIRAIZU LTD.).

### <Polyvalent Metal Salt>

Since the polyvalent metal salt is included in the processing fluid, a coloring material (e.g., a pigment) in an ink is promptly aggregated after being deposited, to thereby prevent color bleeding, and color development can be improved.

A cation in the polyvalent metal salt is not particularly limited and may be appropriately selected depending on the intended purpose. Examples thereof include, but are not limited to, ions of aluminium (Al(III)), calcium (Ca(II)), magnesium (Mg(II)), copper (Cu(II)), iron (Fe(II) or Fe(III)), zinc (Zn(II)), tin (Sn(II) or Sn(IV)), strontium (Sr(II)), nickel (Ni(II)), cobalt (Co(II)), barium (Ba(II)), lead (Pb(II)), zirconium (Zr(IV)), titanium (Ti(IV)), antimony (Sb(III)), bismuth (Bi(III)), tantalum (Ta(V)), arsenic (As(III)), cerium (Ce(III)), lanthanum (La(III)), yttrium (Y(III)), mercury (Hg(II)), and beryllium (Be(II)). Among the above-listed examples, calcium (Ca(II)) and magnesium (Mg(II)) are preferable.

An anion in the polyvalent metal salt is not particularly limited and may be appropriately selected depending on the intended purpose. Examples thereof include, but are not limited to: ions of halogen elements, such as fluorine (F), chloride (Cl), bromide (Br), and iodine (I); nitric acid ions (NO₃⁻) and sulfuric acid ions (SO₄²⁻); ions of organic carboxylic acid, such as formic acid, acetic acid, lactic acid, malonic acid, oxalic acid, maleic acid, and benzoic acid: ions of organic sulfonic acid, such as benzenesulfonic acid, naphthol sulfonic acid, and alkylbenzene sulfonate; and thiocyan ions (SCN⁻, thiosulfric acid ions S₂O₃²⁻), phosphoric acid ions (PO₄³⁻), and nitrous acid ions (NO²⁻). Among the above-listed examples, chlorine ion (CF), sulfuric acid ion (SO₄²⁻), acetic acid ion, and nitric acid ion (NO₃⁻) are preferable considering cost and safety.

The polyvalent metal salt is not particularly limited and may be appropriately selected depending on the intended purpose. Examples thereof include, but are not limited to, salts of a titanium compound, a chromium compound, a copper compound, a cobalt compound, a strontium compound, a barium compound, an iron compound, an aluminium compound, a calcium compound, and a magnesium compound. Among the above-listed examples, a salt of at least one selected from the group consisting of a calcium compound, a magnesium compound, a nickel compound, and an aluminium compound is preferable, and a salt of alkaline earth metal (e.g., calcium and magnesium) is more preferable, as such salts can effectively aggregate a coloring material (e.g., a pigment).

Specific examples of the polyvalent metal salt include, but are not limited to, calcium carbonate, calcium nitrate, calcium chloride, calcium acetate, calcium sulfate, magnesium chloride, magnesium acetate, magnesium sulfate, barium sulfate, zinc sulfate, zinc carbonate, aluminium silicate, calcium silicate, magnesium silicate, and aluminium hydroxide.

A proportion of the polyvalent metal salt in the processing fluid is preferably 1% by mass or greater but 40% by mass or less, and more preferably 2% by mass or greater but 30% by mass or less. When the proportion of the polyvalent metal salt is 2% by mass or greater but 30% by mass or less, bleeding of an image can be minimized, and sharpness of an image can be improved.

### <Coloring Material>

The coloring material is not particularly limited. A pigment or a dye may be used as the coloring material.

As the pigment, an inorganic pigment or an organic pigment can be used. The above-listed pigments may be used alone or in combination. Moreover, mixed crystals may be used as the pigment.

As the pigment, for example, a black pigment, a yellow pigment, a magenta pigment, a cyan pigment, a white pigment, a green pigment, an orange pigment, a gloss pigment (e.g., gold and silver), or a metallic pigment may be used.

As the inorganic pigment, in addition to titanium oxide, iron oxide, calcium carbonate, barium sulfate, aluminium hydroxide, barium yellow, cadmium red, and chrome yellow, carbon black produced by known methods, such as a contact method, a furnace method, and a thermal method, may be used.

As the organic pigment, moreover, an azo pigment, a polycyclic pigment (e.g., a phthalocyanine pigment, a perillene pigment, a perinone pigment, an anthraquinone pigment, a quinacridone pigment, a dioxidine pigment, an indigo pigment, a thioindigo pigment, an isoindolinone pigment, and a quinophthalone pigment), a dye chelate (e.g., a basic dye-based chelate, and an acidic dye-based chelate), a nitro pigment, a nitroso pigment, or aniline black may be used. Among the above-listed pigments, pigments having excellent affinity to a solvent are preferably used. Other than above, hollow resin particles, or hollow inorganic particles may also be used.

Specific examples of the pigment for black include, but are not limited to: carbon black (C.I. Pigment Black 7) such as furnace black, lamp black, acetylene black, and channel black: metals, such as copper, iron (C.I. Pigment Black 11), and titanium oxide; and an organic pigment, such as aniline black (C.I. Pigment Black 1).

Moreover, specific examples of the pigment for colors include, but are not limited to: C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 138, 150, 153, 155, 180, 185, 213; C.I. Pigment Orange 5, 13, 16, 17, 36, 43, 51; C.I. Pigment Red 1, 2, 3, 5, 17, 22, 23, 31, 38, 48:2, 48:2 (Permanent Red 2B(Ca)), 48:3, 48:4, 49:1, 52:2, 53:1, 57:1 (Brilliant Carmine 6B), 60:1, 63:1, 63:2, 64:1, 81, 83, 88, 101 (red iron oxide), 104, 105, 106, 108 (cadmium red), 112, 114, 122 (quinacridone magenta), 123, 146, 149, 166, 168, 170, 172, 177, 178, 179, 184, 185, 190, 193, 202, 207, 208, 209, 213, 219, 224, 254, 264: C.I. Pigment Violet 1 (rhodamine lake), 3, 5:1, 16, 19, 23, 38; C.I. Pigment Blue 1, 2, 15 (phthalocyanine blue), 15:1, 15:2, 15:3, 15:4 (phthalocyanine blue), 16, 17:1, 56, 60, 63; and C.I. Pigment Green 1, 4, 7, 8, 10, 17, 18, 36.

The dye is not particularly limited. As the dye, an acid dye, a direct dye, a reactive dye, and a basic dye can be used, which may be used alone or in combination.

Examples of the dye include, but are not limited to: C.I. Acid Yellow 17, 23, 42, 44, 79, 142; C.I. Acid Red 52, 80, 82, 249, 254, 289; C.I. Acid Blue 9, 45, 249; C.I. Acid Black 1, 2, 24, 94: C.I. Food Black 1, 2; C.I. Direct Yellow 1, 12, 24, 33, 50, 55, 58, 86, 132, 142, 144, 173; C.I. Direct Red 1, 4, 9, 80, 81, 225, 227; C.I. Direct Blue 1, 2, 15, 71, 86, 87, 98, 165, 199, 202; C.I. Direct Black 19, 38, 51, 71, 154, 168, 171, 195; C.I. Reactive Red 14, 32, 55, 79, 249; and C.I. Reactive Black 3, 4, and 35.

A proportion of the coloring material in the processing fluid is not particularly limited and may be appropriately selected depending on the intended purpose. The proportion thereof in the processing fluid is preferably less than 0.1% by mass, more preferably 0.01% by mass or greater but less than 0.1% by mass, and even more preferably 0.05% by mass or greater but less than 0.1% by mass.

### <Water>

The water is not particularly limited and may be appropriately selected depending on the intended purpose. Examples thereof include, but are not limited to, pure water, such as ion-exchanged water, ultrafiltered water, reverse osmosis water, and distilled water, and ultrapure water. The above-listed examples may be used alone or in combination.

A proportion of the water in the processing fluid is not particularly limited and may be appropriately selected depending on the intended purpose. Considering drying speed and discharge reliability of the processing fluid, the proportion of the water in the processing fluid is preferably 10% by mass or greater but 90% by mass or less, and more preferably 20% by mass or greater but 60% by mass or less.

### <Other Components>

The above-mentioned other components are not particularly limited and may be appropriately selected depending on the intended purpose. Examples thereof include, but are not limited to, an organic solvent, a surfactant, a defoaming agent, a preservative and fungicide, and a corrosion inhibitor.

### <<Organic Solvent>>

The organic solvent is not particularly limited. A water-soluble organic solvent can be used as the organic solvent. Examples thereof include, but are not limited to: polyvalent alcohols; ethers, such as polyvalent alcohol alkyl ethers and polyvalent alcohol aryl ethers; nitrogen-containing heterocyclic compounds; amides; amines; and sulfur-containing compounds.

Specific examples of the water-soluble organic solvent include, but are not limited to: polyvalent alcohols, such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butanediol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butanetriol, 1,2,3-butanetriol, 2,2,4-trimethyl-1,3-pentanediol, and 3-methylpentane-1,3,5-triol; polyvalent alcohol alkyl ethers, such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; polyvalent alcohol aryl ethers, such as ethylene glycol monophenyl ether, and ethylene glycol monobenzyl ether; nitrogen-containing heterocyclic compounds, such as 2-pyrrolidone, N-methyl-2-pyrrolidone, N-hydroxyethyl-2-pyrrolidone, 1,3-dimethyl-2-imidazolidinone, ε-caprolactam, and γ-butyrolactone; amides, such as formamide, N-methylformamide, N,N-dimethylformamide, 3-methoxy-N,N-dimethylpropionamide, and 3-butoxy-N,N-dimethylpropionamide; amines, such as monoethanolamine, diethanolamine, and triethylamine; sulfur-containing compounds, such as dimethyl sulfoxide, sulfolane, and thiodiethanol; propylene carbonate; and ethylene carbonate.

As the organic solvent, an organic solvent having a boiling point of 250° C. or lower is preferably used because excellent drying speed can be achieved as well as functioning as a wetting agent.

A proportion of the organic solvent in the processing fluid is not particularly limited and may be appropriately selected depending on the intended purpose. Considering drying speed and discharge reliability of the processing fluid, the proportion thereof in the processing fluid is preferably 10% by mass or greater but 60% by mass or less, and more preferably 20% by mass or greater but 60% by mass or less.

### <<Surfactant>>

As the surfactant, any of a silicone-based surfactant, a fluorine-based surfactant, an amphoteric surfactant, a nonionic surfactant, or an anionic surfactant may be used.

The silicone-based surfactant is not particularly limited and may be appropriately selected depending on the intended purpose. Among the silicone-based surfactants, preferred are silicone-based surfactants that are not decomposed even in a high pH environment. Examples thereof include, but are not limited to, side-chain-modified polydimethylsiloxane, both end-modified polydimethylsiloxane, one-end-modified polydimethylsiloxane, and side-chain-both-end-modified polydimethylsiloxane. A silicone-based surfactant having a polyoxyethylene group or a polyoxyethylene polyoxypropylene group as a modifying group is particularly preferable because such a surfactant exhibits excellent characteristics as an aqueous surfactant.

As the silicone-based surfactant, moreover, a polyether-modified silicone-based surfactant may be used. Examples thereof include, but are not limited to, a compound in which a polyalkylene oxide structure is introduced in a side chain at the Si site of dimethylsiloxane.

As the fluorine-based surfactant, for example, a perfluoroalkyl sulfonic acid compound, a perfluoroalkyl carboxylic acid compound, a perfluoroalkyl phosphoric acid ester compound, a perfluoroalkyl ethylene oxide adduct, and a polyoxyalkylene ether polymer compound having a perfluoroalkyl ether group in a side chain thereof are particularly preferable considering low foamability thereof.

Examples of the perfluoroalkyl sulfonic acid compound include, but are not limited to, perfluoroalkyl sulfonic acid, and perfluoroalkyl sulfonic acid salt. Examples of the perfluoroalkyl carboxylic acid compound include, but are not limited to, perfluoroalkyl carboxylic acid, and perfluoroalkyl carboxylic acid salt.

Examples of the polyoxyalkylene ether polymer compound having a perfluoroalkyl ether group in a side chain thereof include, but are not limited to, sulfuric acid ester salt of a polyoxyalkylene ether polymer having a perfluoroalkyl ether group in a side chain thereof, and salt of a polyoxyalkylene ether polymer having a perfluoroalkyl ether group in a side chain thereof. Examples of a counter ion of the salt of the fluorine-based surfactant include, but are not limited to, Li, Na, K, NH₄, NH₃CH₂CH₂OH, NH₂(CH₂CH₂OH)₂, and NH(CH₂CH₂OH)₃.

Examples of the amphoteric surfactant include, but are not limited to, lauryl aminopropionic acid salt, lauryl dimethyl betaine, stearyl dimethyl betaine, and lauryl dihydroxyethyl betaine.

Examples of the nonionic surfactant include, but are not limited to, polyoxyethylene alkyl phenyl ether, polyoxyethylene alkyl ester, polyoxyethylene alkyl amine, polyoxyethylene alkyl amide, polyoxyethylene propylene block polymer, sorbitan fatty acid ester, polyoxyethylene sorbitan fatty acid ester, and acetylene alcohol ethylene oxide adduct.

Examples of the anionic surfactant include, but are not limited to, polyoxyethylene alkyl ether acetic acid salt, dodecyl benzene sulfonic acid salt, lauric acid salt, and polyoxyethylene alkyl ether sulfate salt.

The above-listed examples may be used alone or in combination.

A proportion of the surfactant in the processing fluid is not particularly limited and may be appropriately selected depending on the intended purpose. Considering excellent wettability, and improved image quality, the proportion of the surfactant in the processing fluid is preferably 0.001% by mass or greater but 5% by mass or less, and more preferably 0.05% by mass or greater but 5% by mass or less.

### <<Defoaming Agent>>

The defoaming agent is not particularly limited. Examples thereof include, but are not limited to, a silicone-based defoaming agent, a polyether-based defoaming agent, and a fatty acid ester-based defoaming agent. The above-listed examples may be used alone or in combination. Among the above-listed examples, a silicone-based defoaming agent is preferable considering an excellent defoaming effect thereof.

### <<Preservative and Fungicide>>

The preservative and fungicide is not particularly limited. Examples thereof include, but are not limited to, 1,2-benzisothiazolin-3-one.

### <<Corrosion Inhibitor>>

The corrosion inhibitor is not particularly limited. Examples thereof include, but are not limited to, acid sulfite, and sodium thiosulfate.

### (Method of Producing Printed Matter and Device of Producing Printed Matter)

The method (“production method”) of producing printed matter of the present disclosure includes a processing fluid applying step, an ink applying step, a drying step, and may further include other steps according to the necessity. The processing fluid applying step is a step including applying the processing fluid of the present disclosure onto a base. The ink applying step is a step including applying an ink including a coloring material onto the base. The drying step is a step including drying the base onto which the ink has been applied.

The device (“production device”) of producing printed matter of the present disclosure includes a processing fluid applying unit, an ink applying unit, and a drying unit, and may further include other units according to the necessity. The processing fluid applying unit is a unit configured to apply the processing fluid of the present disclosure onto a base. The ink applying unit is a unit configured to apply an ink including a coloring material onto the base. The drying unit is a unit configured to dry the base onto which the ink has been applied.

When the processing fluid of the present disclosure is used as a pre-processing fluid used before image formation, the ink applying step where an ink including a coloring material is applied onto the base is an ink applying step including applying an ink including a coloring material onto the base to which the processing fluid has been applied.

Note that, the ink applying step where an ink including a coloring material is applied onto the base includes applying the ink onto the region of the base to which the processing fluid has been applied, and may also include applying the ink to a region of the base to which the processing fluid has not been applied, where the base includes the region to which the processing fluid has been applied.

The production method of printed matter of the present disclosure can be suitably performed by the production device of printed matter of the present disclosure. The processing fluid applying step can be suitably performed by the processing fluid applying unit. The ink applying step can be suitably applied by the ink applying unit. The drying step can be suitably performed by the drying step. The above-mentioned other steps can be suitably performed by the above-mentioned other units.

### <Processing Fluid Applying Step and Processing Fluid Applying Unit>

The processing fluid applying step is a step including applying the processing fluid of the present disclosure onto a base.

The processing fluid applying unit is a unit configured to apply the processing fluid of the present disclosure onto a base.

The base is not particularly limited and may be appropriately selected depending on the intended purpose. Examples thereof include, but are not limited to, a below-described print medium.

The processing fluid applying unit is not particularly limited as long as the processing fluid applying unit can apply the processing fluid onto the base, and may be appropriately selected depending on the intended purpose.

Examples of a method for applying the processing fluid onto the base include, but are not limited to, inkjet coating (system), blade coating, gravure coating, gravure offset coating, bar coating, roll coating, knife coating, air knife coating, comma coating, U-comma coating, AKKU coating, smoothing coating, microgravure coating, reverse roll coating, 4-roll coating, 5-roll coating, dip coating, curtain coating, slide coating, and die coating.

Among the above-listed examples, inkjet coating (system) is preferable. When the processing fluid is applied by inkjet coating, the processing fluid can be uniformly applied over the entire area of the base, and the minimum amount necessary for coating can be applied by adjusting the droplet size. Therefore, the application of the processing fluid by inkjet coating is particularly preferable. Since the processing fluid is uniformly applied onto the surface of the base by inkjet coating, moreover, the acrylic resin particles and the polyvalent metal salt are uniformly distributed over the surface of the base without unevenness. Therefore, there is no variation in abrasion resistance or sharpness of an image depending on the position within the base surface, leading to a high quality image.

An amount of the processing fluid applied onto the base is preferably 3 g/m² or greater but 20 g/m² or less, and more preferably 6 g/m² or greater but 10 g/m² or less. When the amount thereof is 3 g/m² or greater but 20 g/m² or less, excellent abrasion resistance can be achieved and an effect of preventing bleeding of an image can be improved.

### <Ink Applying Step and Ink Applying Unit>

The ink applying step is a step including applying an ink including a coloring material onto the base.

The ink applying unit is a unit configured to apply an ink including a coloring material onto the base.

The ink applying unit is not particularly limited and may be appropriately selected depending on the intended purpose.

Examples of the application method by the ink applying unit include, but are not limited to, inkjet coating (system), blade coating, gravure coating, gravure offset coating, bar coating, roll coating, knife coating, air knife coating, comma coating, U-comma coating, AKKU coating, smoothing coating, microgravure coating, reverse roll coating, 4-roll coating, 5-roll coating, dip coating, curtain coating, slide coating, and die coating.

### [Ink]

An organic solvent, water, a coloring material, a resin, additives etc. used for the ink will be described hereinafter.

### -Organic Solvent-

The organic solvent is not particularly limited. A water-soluble organic solvent can be used as the organic solvent. Examples thereof include, but are not limited to: polyvalent alcohols; ethers, such as polyvalent alcohol alkyl ethers and polyvalent alcohol aryl ethers; nitrogen-containing heterocyclic compounds; amides, amines; and sulfur-containing compounds.

Specific examples of the water-soluble organic solvent include, but are not limited to: polyvalent alcohols, such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butanediol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butanetriol, 1,2,3-butanetriol, 2,2,4-trimethyl-1,3-pentanediol, and 3-methylpentane-1,3,5-triol: polyvalent alcohol alkyl ethers, such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; polyvalent alcohol aryl ethers, such as ethylene glycol monophenyl ether, and ethylene glycol monobenzyl ether; nitrogen-containing heterocyclic compounds, such as 2-pyrrolidone, N-methyl-2-pyrrolidone. N-hydroxyethyl-2-pyrrolidone, 1,3-dimethyl-2-imidazolidinone, ε-caprolactam, and γ-butyrolactone; amides, such as formamide, N-methylformamide, N,N-dimethylformamide, 3-methoxy-N,N-dimethylpropionamide, and 3-butoxy-N,N-dimethylpropionamide; amines, such as monoethanolamine, diethanolamine, and triethylamine; sulfur-containing compounds, such as dimethyl sulfoxide, sulfolane, and thiodiethanol; propylene carbonate; and ethylene carbonate.

As the organic solvent, an organic solvent having a boiling point of 250° C. or lower is preferably used because excellent drying speed can be achieved as well as functioning as a wetting agent.

As the organic solvent, a C8 or higher polyol compound and a glycol ether compound are also suitably used. Specific examples of the C8 or higher polyol compound include, but are not limited to, 2-ethyl-1,3-hexanediol, and 2,2,4-trimethyl-1,3-pentanediol.

Specific examples of the glycol ether compound include, but are not limited to: polyvalent alcohol alkyl ethers, such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; and polyvalent alcohol aryl ethers, such as ethylene glycol monophenyl ether, and ethylene glycol monobenzyl ether.

When paper is used as a print medium, the C8 or higher polyol compound and the glycol ether compound can improve permeability of the ink.

A proportion of the organic solvent in the ink is not particularly limited and may be appropriately selected depending on the intended purpose. Considering drying speed and discharge stability of the ink, the proportion of the organic solvent in the ink is preferably 10% by mass or greater but 60% by mass or less, and more preferably 20% by mass or greater but 60% by mass or less.

### -Water-

A proportion of the water in the ink is not particularly limited and may be appropriately selected depending on the intended purpose. Considering drying speed of the ink and discharge stability, the proportion of the water in the ink is preferably 10% by mass or greater but 90% by mass or less, and more preferably 20% by mass or greater but 60% by mass or less.

### -Coloring Material-

The coloring material is not particularly limited. As the coloring material, a pigment or a dye may be used.

As the pigment, an inorganic pigment or an organic pigment can be used. The above-listed pigments may be used alone or in combination. Moreover, mixed crystals may be used as the pigment.

As the pigment, for example, a black pigment, a yellow pigment, a magenta pigment, a cyan pigment, a white pigment, a green pigment, an orange pigment, a gloss pigment of gold or silver, or a metallic pigment may be used.

As the inorganic pigment, in addition to titanium oxide, iron oxide, calcium carbonate, barium sulfate, aluminium hydroxide, barium yellow, cadmium red, and chrome yellow, carbon black produced by known methods, such as a contact method, a furnace method, and a thermal method, may be used.

As the organic pigment, moreover, an azo pigment, a polycyclic pigment (e.g., a phthalocyanine pigment, a perillene pigment, a perinone pigment, an anthraquinone pigment, a quinacridone pigment, a dioxidine pigment, an indigo pigment, a thioindigo pigment, an isoindolinone pigment, and a quinophthalone pigment), a dye chelate (e.g., a basic dye-based chelate, and an acidic dye-based chelate), a nitro pigment, a nitroso pigment, or aniline black may be used. Among the above-listed pigments, pigments having excellent affinity to a solvent are used. Other than above, hollow resin particles, or hollow inorganic particles may also be used.

Specific examples of the pigment for black include, but are not limited to: carbon black (C.I. Pigment Black 7) such as furnace black, lamp black, acetylene black, and channel black: metals, such as copper, iron (C.I. Pigment Black 11), and titanium oxide; and an organic pigment, such as aniline black (C.I. Pigment Black 1).

Moreover, specific examples of the pigment for colors include, but are not limited to: C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 138, 150, 153, 155, 180, 185, 213; C.I. Pigment Orange 5, 13, 16, 17, 36, 43, 51; C.I. Pigment Red 1, 2, 3, 5, 17, 22, 23, 31, 38, 48:2 (Permanent Red 2B(Ca)), 48:3, 48:4, 49:1, 52:2, 53:1, 57:1 (Brilliant Carmine 6B), 60:1, 63:1, 63:2, 64:1, 81, 83, 88, 101 (red iron oxide), 104, 105, 106, 108 (cadmium red), 112, 114, 122 (quinacridone magenta), 123, 146, 149, 166, 168, 170, 172, 177, 178, 179, 184, 185, 190, 193, 202, 207, 208, 209, 213, 219, 224, 254, 264: C.I. Pigment Violet 1 (rhodamine lake), 3, 5:1, 16, 19, 23, 38; C.I. Pigment Blue 1, 2, 15 (phthalocyanine blue), 15:1, 15:2, 15:3, 15:4 (phthalocyanine blue), 16, 17:1, 56, 60, 63; and C.I. Pigment Green 1, 4, 7, 8, 10, 17, 18, 36,

The dye is not particularly limited. As the dye, an acid dye, a direct dye, a reactive dye, and a basic dye can be used, which may be used alone or in combination.

Examples of the dye include, but are not limited to: C.I. Acid Yellow 17, 23, 42, 44, 79, 142; C.I. Acid Red 52, 80, 82, 249, 254, 289; C.I. Acid Blue 9, 45, 249; C.I. Acid Black 1, 2, 24, 94: C.I. Food Black 1, 2; C.I. Direct Yellow 1, 12, 24, 33, 50, 55, 58, 86, 132, 142, 144, 173; C.I. Direct Red 1, 4, 9, 80, 81, 225, 227; C.I. Direct Blue 1, 2, 15, 71, 86, 87, 98, 165, 199, 202; C.I. Direct Black 19, 38, 51, 71, 154, 168, 171, 195; C.I. Reactive Red 14, 32, 55, 79, 249; and C.I. Reactive Black 3, 4, and 35.

A proportion of the coloring material in the ink is preferably 0.1% by mass or greater but 15% by mass or less, and more preferably 1% by mass or greater but 10% by mass or less, considering improved image density and excellent fixability and discharge stability.

Examples of the method for dispersing the pigment to obtain an ink include, but are not limited to: a method where a hydrophilic functional group is introduced into a pigment to form a self-dispersible pigment; a method where a surface of a pigment is covered with a resin to disperse the pigment; and a method where a dispersant is used to disperse a pigment.

Examples of the method where a hydrophilic functional group is introduced into a pigment to form a self-dispersible pigment include, but are not limited to, a method where a functional group (e.g., a sulfone group and a carboxyl group) is added to a pigment (e.g., carbon) to make the pigment dispersible in water.

Examples of the method where a surface of a pigment is covered with a resin to disperse the pigment include, but are not limited to, a method where a pigment is encapsulated in microcapsules to make the pigment dispersible in water. Such a pigment can be also referred to as a resin-coated pigment. In this case, all of the pigment particles included in the ink are not necessarily coated with a resin, and pigment particles that are not coated with the resin or pigment particles that are partially coated with the resin may be dispersed in the ink as long as an obtainable effect of the present disclosure is not adversely affected.

Examples of the method where a dispersant is used to disperse a pigment include, but are not limited to, a method where a pigment is dispersed using a known low molecular weight or high molecular weight dispersant, such as a surfactant.

As the dispersant, for example, an anionic surfactant, a cationic surfactant, an amphoteric surfactant, or a nonionic surfactant may be used depending on the pigment for use.

RT-100 (nonionic surfactant) available from TAKEMOTO OIL & FAT CO., LTD. or a formalin condensate of naphthalene sodium sulfonate may be also suitably used as the dispersant.

The above-listed dispersants may be used alone or in combination.

### -Pigment Dispersion-

The ink can be obtained by mixing materials, such as water and an organic solvent, with the pigment. Moreover, the ink can be produced by mixing materials, such as water and an organic solvent, with a pigment dispersion obtained by mixing the pigment and others, such as water and a dispersant.

The pigment dispersion is obtained by mixing water, a pigment, a pigment dispersant, and other optionally used other components together, dispersing, and adjusting particle diameters thereof. The dispersion may be performed by means of a disperser.

The particle diameter of the pigment in the pigment dispersion is not particularly limited. Considering excellent dispersion stability of the pigment, and favorable discharge stability and image quality, such as image density, the maximum frequency as determined by the maximum number conversion is preferably 20 nm or greater but 500 nm or less, and more preferably 20 nm or greater but 150 nm or less. The particle diameter of the pigment can be measured by means of a particle size analyzer (Nanotrac Wave-UT151, available from MicrotracBEL Corp.).

A proportion of the pigment in the pigment dispersion is not particularly limited and may be appropriately selected depending on the intended purpose. In order to achieve excellent discharge stability and high image density, the proportion thereof in the pigment dispersion is preferably 0.1% by mass or greater but 50% by mass or less, and more preferably 0.1% by mass or greater but 30% by mass or less.

Optionally coarse particles are preferably removed from the pigment dispersion by a filter, a centrifuge, etc., followed by degassing.

### -Resin-

A type of the resin included in the ink is not particularly limited and may be appropriately selected depending on the intended purpose. Examples thereof include, but are not limited to, a urethane-based resin, a polyester-based resin, an acryl-based resin, a vinyl acetate-based resin, a styrene-based resin, a butadiene-based resin, a styrene-butadiene-based resin, a vinyl chloride-based resin, an acryl styrene-based resin, and an acryl silicone-based resin.

Resin particles formed of any of the above-listed resins may be also used. An ink can be obtained by blending materials, such as a coloring material and an organic solvent, with the resin particles in the state of the resin emulsion in which the resin particles are dispersed in water serving as a dispersion medium. The resin particles may be appropriately synthesized for use or may be selected from commercial products. The above-listed resin particles may be used alone, or two or more types of the resin particles may be used in combination.

The volume average particle diameter of the resin particles is not particularly limited and may be appropriately selected depending on the intended purpose. In order to achieve excellent fixability and high hardness of an image, the volume average particle diameter thereof is preferably 10 nm or greater but 1,000 nm or less, more preferably 10 nm or greater but 200 nm or less, and particularly preferably 10 nm or greater but 100 nm or less.

The volume average particle diameter can be measured, for example, by means of a particle size analyzer (Nanotrac Wave-UT151, available from MicrotracBEL Corp.).

A proportion of the resin in the ink is not particularly limited and may be appropriately selected depending on the intended purpose. Considering fixability and storage stability of the ink, the proportion of the resin in the ink is preferably 1% by mass or greater but 30% by mass or less, and more preferably 5% by mass or greater but 20% by mass or less.

Particle diameters of solids in the ink are not particularly limited and may be appropriately selected depending on the intended purpose. Considering discharge stability, and high image quality, such as image density, the maximum frequency as determined by the maximum number conversion is preferably 20 nm or greater but 1,000 nm or less, and more preferably 20 nm or greater but 150 nm or less. The solids include resin particles, particles of the pigment, etc. The particle diameters can be measured by means of a particle size analyzer (Nanotrac Wave-UT151, available from MicrotracBEL Corp.).

### -Additive-

The ink may optionally include a surfactant, a defoaming agent, preservative and fungicide, corrosion inhibitor, and a pH regulator.

### --Surfactant--

As the surfactant, any of a silicone-based surfactant, a fluorine-based surfactant, an amphoteric surfactant, a nonionic surfactant, or an anionic surfactant may be used.

The silicone-based surfactant is not particularly limited and may be appropriately selected depending on the intended purpose. Among the silicone-based surfactants, preferred are silicone-based surfactants that are not decomposed even in a high pH environment. Examples thereof include, but are not limited to, side-chain-modified polydimethylsiloxane, both end-modified polydimethylsiloxane, one-end-modified polydimethylsiloxane, and side-chain-both-end-modified polydimethylsiloxane. A silicone-based surfactant having a polyoxyethylene group or a polyoxyethylene polyoxypropylene group as a modifying group is particularly preferable because such a surfactant exhibits excellent characteristics as an aqueous surfactant.

As the silicone-based surfactant, moreover, a polyether-modified silicone-based surfactant may be used. Examples thereof include, but are not limited to, a compound in which a polyalkylene oxide structure is introduced in a side chain at the Si site of dimethylsiloxane.

As the fluorine-based surfactant, for example, a perfluoroalkyl sulfonic acid compound, a perfluoroalkyl carboxylic acid compound, a perfluoroalkyl phosphoric acid ester compound, a perfluoroalkyl ethylene oxide adduct, and a polyoxyalkylene ether polymer compound having a perfluoroalkyl ether group in a side chain thereof are particularly preferable considering low foamability thereof. Examples of the perfluoroalkyl sulfonic acid compound include, but are not limited to, perfluoroalkyl sulfonic acid, and perfluoroalkyl sulfonic acid salt. Examples of the perfluoroalkyl carboxylic acid compound include, but are not limited to, perfluoroalkyl carboxylic acid, and perfluoroalkyl carboxylic acid salt.

Examples of the polyoxyalkylene ether polymer compound having a perfluoroalkyl ether group in a side chain thereof include, but are not limited to, sulfuric acid ester salt of a polyoxyalkylene ether polymer having a perfluoroalkyl ether group in a side chain thereof, and salt of a polyoxyalkylene ether polymer having a perfluoroalkyl ether group in a side chain thereof. Examples of a counter ion of the salt of the fluorine-based surfactant include, but are not limited to, Li, Na, K, NH₄, NH₃CH₂CH₂OH, NH₂(CH₂CH₂OH)₂, and NH(CH₂CH₂OH)₃.

Examples of the amphoteric surfactant include, but are not limited to, lauryl aminopropionic acid salt, lauryl dimethyl betaine, stearyl dimethyl betaine, and lauryl dihydroxyethyl betaine.

Examples of the nonionic surfactant include, but are not limited to, polyoxyethylene alkyl phenyl ether, polyoxyethylene alkyl ester, polyoxyethylene alkyl amine, polyoxyethylene alkyl amide, polyoxyethylene propylene block polymer, sorbitan fatty acid ester, polyoxyethylene sorbitan fatty acid ester, and acetylene alcohol ethylene oxide adduct.

Examples of the anionic surfactant include, but are not limited to, polyoxyethylene alkyl ether acetic acid salt, dodecyl benzene sulfonic acid salt, lauric acid salt, and polyoxyethylene alkyl ether sulfate salt.

The above-listed examples may be used alone or in combination.

The silicone-based surfactant is not particularly limited and may be appropriately selected depending on the intended purpose. Examples thereof include, but are not limited to, side-chain-modified polydimethylsiloxane, both end-modified polydimethylsiloxane, one-end-modified polydimethylsiloxane, side-chain-both-end-modified polydimethylsiloxane. A silicone-based surfactant having a polyoxyethylene group or a polyoxyethylene polyoxypropylene group as a modifying group is particularly preferable because such a surfactant exhibits excellent characteristics as an aqueous surfactant.

Any of the above-listed surfactants for use may be appropriately synthesized, or may be selected from commercial products. For example, the commercial products thereof may be acquired from BYK-Chemie GmbH, Shin-Etsu Chemical Co., Ltd., Dow Corning Toray Co., Ltd., NIHON EMULSION Co., Ltd., Kyoeisha Chemical Co., Ltd., etc.

The above-mentioned polyether-modified silicone-based surfactant is not particularly limited and may be appropriately selected depending on the intended purpose. Examples thereof include, but are not limited to, a compound represented by General Formula (S-1), in which a polyalkylene oxide structure is introduced into a side chain of the Si site of dimethyl polysiloxane.

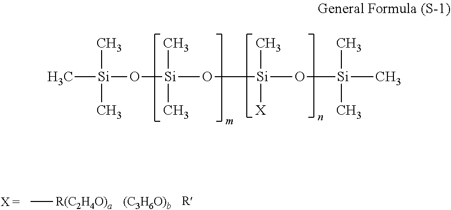

In General Formula (S-1), m, n, a, and b are each independently an integer, R is an alkylene group, and R′ is an alkyl group.

As the polyether-modified silicone-based surfactant, commercial products may be used. Examples thereof include, but are not limited to: KF-618, KF-642, and KF-643 (available from Shin-Etsu Chemical Co., Ltd.); EMALEX-SS-5602, and SS-1906EX (available from NIHON EMULSION Co., Ltd.); FZ-2105, FZ-2118, FZ-2154, FZ-2161, FZ-2162, FZ-2163, and FZ-2164 (available from Dow Corning Toray Co., Ltd.); BYK-33, and BYK-387 (available from BYK-Chemie GmbH): and TSF4440, TSF4452, and TSF4453 (available from Momentive Performance Materials Inc.).

The fluorine-based surfactant is preferably a compound, in which the number of carbon atoms substituted with fluorine is from 2 through 16, and more preferably a compound, in which the number of carbon atoms substituted with fluorine is from 4 through 16.

Examples of the fluorine-based surfactant include, but are not limited to, a perfluoroalkyl phosphoric acid ester compound, a perfluoroalkyl ethylene oxide adduct, and a polyoxyalkylene ether polymer compound having a perfluoroalkyl ether group in a side chain thereof. Among the above-listed examples, a polyoxyalkylene ether polymer compound having a perfluoroalkyl ether group in a side chain thereof is preferable considering low foamability thereof, and fluorine-based surfactants represented by General Formulae (F-1) and (F-2) are particularly preferable.

CF₃CF₂(CF₂CF₂)ₘ—CH₂CH₂O(CH₂CH₂O)ₙH General Formula (F-1)

In order to impart water solubility, in the compound represented by General Formula (F-1), m is preferably an integer of from 0 through 10, and n is preferably an integer of from 0 through 40.

CₙF₂ₙ₊₁—CH₂CH(OH)CH₂—O—(CH₂CH₂O)ₙ—Y General Formula (F-2)

In the compound represented by General Formula (F-2), Y is H, or CmF₂ₘ₊₁ where m is an integer of from 1 through 6, or CH₂CH(OH)CH₂—CmF₂ₘ₊₁ where m is an integer of from 4 through 6, or CpH₂ₚ₊₁ where p is an integer of from 1 through 19; n is an integer of from 1 through 6; and a is an integer of from 4 through 14.

As the fluorine-based surfactant, commercial products may be used. Examples of the commercial products thereof include, but are not limited to: SURFLON S-111, S-112, S-113, S-121, S-131, S-132, S-141, and S-145 (all available from ASAHI GLASS CO., LTD.); FLUORAD FC-93, FC-95, FC-98, FC-129, FC-135, FC-170C, FC-430, and FC-431 (all available from SUMITOMO 3M); MEGAFACE F-470, F-1405, and F-474 (all available from DIC CORPORATION); Zonyl TBS, FSP, FSA, FSN-100, FSN, FSO-100, FSO, FS-300, and UR, and CAPSTONE FS-30, FS-31, FS-3100, FS-34, and FS-35 (all available from The Chemours Company); FT-110, FT-250, FT-251, FT-400S, FT-150, and FT-400SW (all available from NEOS COMPANY LIMITED); POLYFOX PF-136A,PF-156A, PF-151N, PF-154, and PF-159 (available from OMNOVA SOLUTIONS INC.); and UNIDYNE DSN-403N (available from DAIKIN INDUSTRIES). Among the above-listed examples, FS-3100, FS-34, and FS-300 (available from The Chemours Company), FT- 110, FT-250, FT-251, FT-400S, FT-150, and FT-400SW (available from NEOS COMPANY LIMITED), POLYFOX PF-151N (available from OMNOVA SOLUTIONS INC.), and UNIDYNEDSN-403N (available from DAIKIN INDUSTRIES) are particularly preferable considering excellent printing quality, especially color development, and significant improvements in permeation to paper, wettability and uniform dyeing.

A proportion of the surfactant in the ink is not particularly limited and may be appropriately selected depending on the intended purpose. Considering excellent wettability and discharge stability, and improved image quality, the proportion of the surfactant in the ink is preferably 0.001% by mass or greater but 5% by mass or less, and more preferably 0.05% by mass or greater but 5% by mass or less.

### --Defoaming Agent--

The defoaming agent is not particularly limited. Examples thereof include, but are not limited to, a silicone-based defoaming agent, a polyether-based defoaming agent, and a fatty acid ester-based defoaming agent. The above-listed examples may be used alone or in combination. Among the above-listed examples, a silicone-based defoaming agent is preferable considering an excellent defoaming effect.

### --Preservative and Fungicide--

The preservative and fungicide is not particularly limited. Examples thereof include, but are not limited to, 1,2-benzisothiazolin-3-one.

### --Corrosion Inhibitor--

The corrosion inhibitor is not particularly limited. Examples thereof include, but are not limited to, acid sulfite, and sodium thiosulfate.

### --pH Regulator--

The pH regulator is not particularly limited as long as the pH regulator can adjust the pH to 7 or higher. Examples thereof include, but are not limited to, amines, such as diethanolamine, and triethanolamine.

The physical properties of the ink are not particularly limited and may be appropriately selected depending on the intended purpose. For example, the viscosity, surface tension. pH etc. of the ink are preferably within the following ranges.

The viscosity of the ink at 25° C. is 5 mPa-s or greater but 30 mPa-s or less, and more preferably 5 mPa·s or greater but 25 mPa·s or less because image density and letter print quality are improved and excellent discharge performance is achieved. For example, the viscosity can be measured by means of a rotary viscometer (RE-80L, available from TOKI SANGYO CO., LTD.). As measuring conditions, the measurement can be performed at 25° C., at 50 rpm for 3 minutes with a standard cone rotor (1° 34′×R24), and with a sample fluid amount of 1.2 mL.

The surface tension of the ink at 25° C. is preferably 35 mN/m or less, and more preferably 32 mN/m or less considering desirable leveling of the ink on a print medium and a short drying time of the ink.

The pH of the ink is preferably from 7 through 12, and more preferably from 8 through 11 considering anti-corrosion of a metal member to be in contact with the ink.

### [Print Medium]

A print medium used for printing is not particularly limited. Examples thereof include, but are not limited to, plain paper, gloss paper, special paper, a film, a transparent plastic film, and general printing paper.

The print medium is not limited to those used as typical print media. As the print medium, building materials (e.g., wallpaper, floor materials, and tiles), fabrics (e.g., T-shirts and fabrics for clothes), textiles, and leather may be appropriately used. Moreover, ceramics, glass, or a metal may be used by appropriately adjusting a structure of a transporting channel of the print medium.

### [Printed Matter]

Printed matter of the present disclosure includes a print medium, and an image formed with the ink of the present disclosure on the print medium.

The printed matter can be obtained by printing by means of an inkjet printing device according to an inkjet printing method.

### [Printing Device and Printing Method]

The present disclosure can be suitably used for various printing devices according to an inkjet recording system, such as printers, facsimile machines, photocopiers, printer/fax/photocopier multifunction peripherals, and 3D model manufacturing devices.

In the present disclosure, the term “printing device” means a device capable of discharging any of inks and various processing fluids towards a print medium, and the term “printing method” means a method for printing using the above-mentioned printing device. The term “print medium” means a medium on which any of inks and various processing fluids can be deposited at least temporarily.

The printing device may include, not only a head configured to discharge an ink, but also units associated with feeding, transporting, and paper ejection of the print medium, and other devices, such as a pre-processing device and a post-processing device.

The printing device used for the printing method may include a heating unit used for a heating step, and a drying unit used for a drying step. For example, the heating unit and the drying unit include a unit configured to heat or dry a printed surface or back surface of the print medium. The heating unit and the drying unit are not particularly limited. For example, a fan heater, or an IR heater may be used. The heating and drying may be performed before, during, or after printing.

The printing device and the printing method are not limited to application for visualization of meaningful images, such as texts and figured, with the ink. For example, the printing device and the printing method are also used for forming patterns, such as geometric designs, and shaping 3D images.

Unless otherwise stated, the printing device includes both a serial type device, in which a discharge head is driven to move, and a line-type device, in which a discharge head is not driven to move.

Furthermore, in addition to the desktop type, this printing device includes a wide type capable of printing images on a large print medium such as A0, a continuous printer capable of using continuous paper wound up in a roll form as print media.

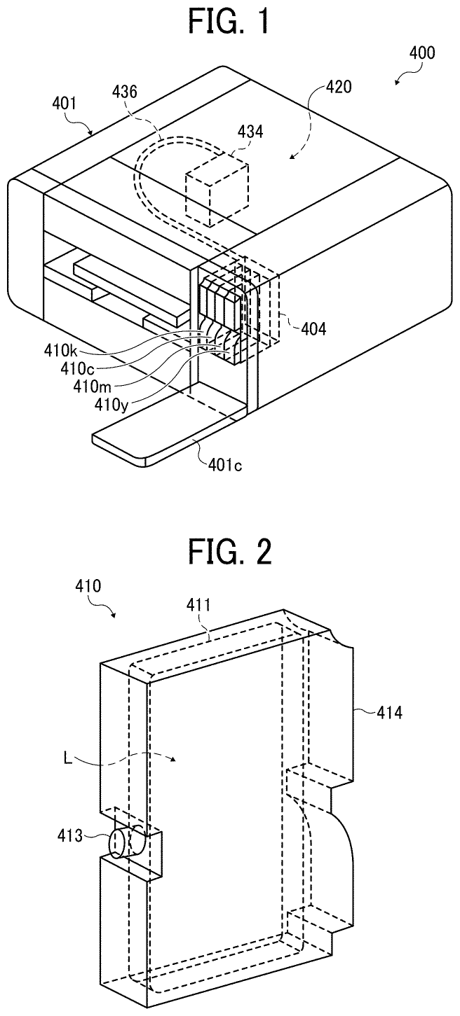

An example of the printing device will be described with reference to FIGS. 1 and 2. FIG. 1 is a perspective view illustrating the printing device. FIG. 2 is a perspective view of a main tank. The image forming apparatus 400 as an example of the printing device is a serial type image forming apparatus. A mechanical unit 420 is disposed in a housing 401 of the image forming apparatus 400. An ink storage unit 411 of each of main tanks 410 (410k, 410c, 410m, 410y) for colors, black (K), cyan (C), magenta (M), and yellow (Y) is formed of a packing member, such as an aluminium laminate film L. The ink storage unit 411 is, for example, stored in a plastic storage container case 414. Therefore, the main tank 410 can be used as an ink cartridge of each color.

A cartridge holder 404 is disposed at the rear side of the opening when a cover 401c of the apparatus main body is opened. The main tank 410 is detachably mounted in the cartridge holder 404. As a result, each ink outlet 413 of the main tank 410 and a discharge head 434 of each color are communicated via a supply tube 436 of each color, and the ink can be discharged from the discharge head 434 to a print medium.

The printing device may include, not only the unit for discharging the ink, but also devices, such as a pre-processing device and a post-processing device.

As an embodiment of the pre-processing device and the post-processing device, similarly to the case of an ink of black (K), cyan (C), magenta (M), or yellow (Y), there is an embodiment where a liquid storage unit including the pre-processing fluid or the post-processing fluid and the liquid discharging head are added to discharge the pre-processing fluid or the post-processing fluid according to an inkjet printing system.

As another embodiment of the pre-processing device and the post-processing device, there is an embodiment where the pre-processing device or the post-processing device other than the inkjet recording system, such as blade coating, roll coating, and spray coating, is disposed.

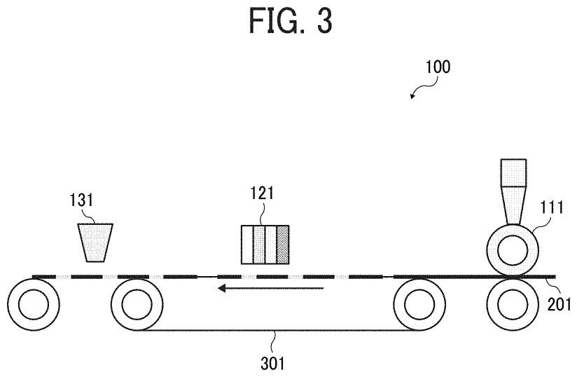

FIG. 3 is a schematic view illustrating one example of a production device of printed matter using the processing fluid of the present disclosure. A production device 100 of printed matter illustrated in FIG. 3 includes a processing fluid applying unit 111, and an ink applying unit 121. The production device 100 of printed matter may further include a drying unit 131.

In the production device 100 of printed matter illustrated in FIG. 3, a print medium 201 is transported along the direction presented with the arrow in FIG. 3 by a conveyance belt 301 to perform the processing fluid applying step with the processing fluid applying unit 111, the ink applying step with the ink applying unit 121, and the drying step with the drying unit 131.

A method for using the ink is not limited to an inkjet printing method, and the ink can be used by various methods. In addition to the inkjet printing method, examples thereof include, but are not limited to, blade coating, gravure coating, bar coating, roll coating, dip coating, curtain coating, slide coating, die coating, and spray coating.

Use of the ink of the present disclosure is not particularly limited and may be appropriately selected depending on the intended purpose. For example, the ink may be applied for printed matter, coating agents, coating materials, inks for foundation. Moreover, the ink may be used not only for forming two-dimensional letters or images, but also as a 3D modeling material for forming a three-dimensional object (3D model).

The 3D modeling device for forming the 3D model is not particularly limited and may be selected from those known in the art for use. For example, a device including an ink storage unit, an ink supply unit, a discharge unit, a drying unit, etc. may be used. The 3D model include a 3D model obtained by superimposing the ink. Moreover, the 3D model also includes a shaped product obtained by processing a structure in which the ink is applied on a base, such as a print medium. The shaped product is a product obtained by shaping, such as heat drawing and punching, a print or structure formed into a sheet or a film. For example, the 3D modeling device is suitably used for shaping after decorating surfaces, such as gauges or panels of control units of vehicles, office appliances, electric or electronic devices, and cameras.

In the present disclosure, the terms “image formation,” “recording,” “printing” etc. are all synonyms.

In the present disclosure, the terms “print medium,” “medium,” and “printing target” are all synonyms.

### <Drying Step and Drying Unit>

The drying step is a step including drying the base onto which the ink has been applied.

The drying unit is a unit configured to dry the base onto which the ink has been applied.

The drying unit is not particularly limited and may be appropriately selected depending on the intended purpose. Examples thereof include, but are not limited to, an infrared (IR) dryer, a drying oven, and a hot plate. Among the above-listed examples, an infrared (IR) drier is preferable. When the drying unit is an infrared (IR) drier, the nonionic acrylic resin particles in the processing fluid are directly heated by IR heating to form a film, which increase adhesion strength between the base, the processing fluid layer, and the ink film. As a result, abrasion resistance can be improved.

The drying temperature in the drying step is not particularly limited and may be appropriately selected depending on the intended purpose. The drying temperature is preferably 50° C. or higher but 200° C. or lower. The drying temperature may be a set temperature of the drying unit used in the drying step, or a temperature determined by measuring a temperature of the base in contact or non-contact manner.

The drying time in the drying step is not particularly limited and may be appropriately selected depending on the intended purpose. The drying time is preferably 0.01 minutes or longer but 1 minute or shorter.

### <Other Steps and Other Units>

The above-mentioned other steps are not particularly limited and may be appropriately selected depending on the intended purpose.

The above-mentioned other units are not particularly limited and may be appropriately selected depending on the intended purpose.

### EXAMPLES

The present disclosure will be described below by way of Examples. The present disclosure should not be construed as being limited to these Examples. Unless otherwise stated, in Examples, preparations and evaluations of processing fluids and inks were performed at a room temperature of 25° C. and humidity of 60% RH.

### <Preparation of Resin Particle Dispersion Liquid 1>

A mixture including 45 parts by mass of styrene, 50 parts by mass of 2-ethylhexyl acrylate, 3 parts by mass of EMULGEN 985 (available from Kao Corporation), 2.75 parts by weight of VA-086 (available from FUJIFILM Wako Pure Chemical Corporation), and 52 parts by mass of ion-exchanged water was emulsified by means of HOMOMIXER to thereby obtain a homogeneous milky white emulsified liquid.

A 250 mL flask equipped with a stirrer, a thermometer, a nitrogen gas inlet tube, and a reflux tube was charged with 58 parts by mass of ion-exchanged water and 2 parts by mass of EMULGEN 920 (available from Kao Corporation). To the resultant mixture, 5 parts by mass of styrene was added, and the resultant was stirred to thereby an emulsified dispersion liquid. With introducing nitrogen into the flask, the emulsified dispersion liquid was heated to 70° C., and 0.25 parts by mass of VA-086 was added to initiate polymerization. One hour after the initiation of the polymerization, and the temperature of the system was increased to 80° C., followed by continuously adding the previously prepared emulsified liquid through dripping for 3 hours. After completing the dripping, the resultant was matured at 70° C. for 2 hours. The residual monomers were removed from the resultant by a conventional method, and the solid content thereof was adjusted to 35% by mass, to thereby obtain Resin Particle Dispersion Liquid 1. The volume average particle diameter of the obtained resin particles was 200 nm. The volume average particle diameter of the resin particles was measured by means of a particle size analyzer (Nanotrac Wave-UT151, available from MicrotracBEL Corp.).

### <Preparation of Resin Particle Dispersion Liquid 2>

Resin Particle Dispersion Liquid 2 was obtained in the same manner as in Preparation of Resin Particle Dispersion Liquid 1, except that the amount of EMULGEN 985 was changed to 5 parts by mass. The volume average particle diameter of the obtained resin particles was 100 nm.

### <Preparation of Resin Particle Dispersion Liquid 3>

Resin Particle Dispersion Liquid 3 was obtained in the same manner as in Preparation of Resin Particle Dispersion Liquid 1, except that the amount of EMULGEN 985 was changed to 2 parts by mass. The volume average particle diameter of the obtained resin particles was 300 nm.

### <Preparation of Resin Particle Dispersion Liquid 4>

Resin Particle Dispersion Liquid 4 was obtained in the same manner as in Preparation of Resin Particle Dispersion Liquid 1, except that the amount of EMULGEN 985 was changed to 5 parts by mass, and the duration for dripping the emulsified liquid was changed to 4.5 hours. The volume average particle diameter of the obtained resin particles was 70 nm.

### <Preparation of Resin Particle Dispersion Liquid 5>

Resin Particle Dispersion Liquid 5 was obtained in the same manner as in Preparation of Resin Particle Dispersion Liquid 1, except that the amount of EMULGEN 985 was changed to 0.75 parts by mass. The volume average particle diameter of the obtained resin particles was 350 nm.

### [Preparation of Processing Fluid 1]

Processing Fluid 1 was prepared by blending materials of the following composition, and then mixing and string the mixture, followed by filtering through a filter (Minisart, available from Satorius AG) of 5 μm.

1,2-Propanediol: 20 parts by weight
Ethylene glycol monobutyl ether: 10 parts by mass
EMULGEN LS-106 (surfactant available from Kao Corporation): 0.5 parts by mass
Magnesium sulfate: 2 parts by mass
Resin Particle Dispersion Liquid 1: 3 parts by mass
PROXEL LV (antiseptic agent, available from Avecia): 0.1 parts by mass
Ion-exchanged water: 64.4 parts by mass

The average reflectance of Processing Fluid 1 after the filtration to light having a wavelength range of from 400 nm to 700 nm was 95%. The average reflectance was determined by diluting the sample 1,000-fold with ion-exchanged water, measuring the diluted sample by means of a spectrophotometer (U-3900H, available from Hitachi High-Tech Science Corporation) 3 times under the following measuring conditions, and calculating an average value of the measured values.

### <Measuring Conditions>

Measuring mode: wavelength scan
Data mode: % R
Onset wavelength: 800 nm
Offset wavelength: 200 nm
Scanning speed: 300 nm/min
Sampling interval: 0.5 nm

### Slit: 2 nm

The reflectance of the reflected light w % ben irradiated with light having wavelengths of 400 nm or greater but 700 nm or less was measured.

### [Preparation of Processing Fluids 2 to 16]

Processing Fluids 2 to 16 were prepared according to the compositions presented in Tables 1 and 2. Note that, the unit for the numeral values in the tables is % by mass.

TABLE 1

| | | Processing fluid | | | | | | | | | | | |
|---|---|---|---|---|---|---|---|---|---|---|---|---|---|
| | | 1 | 2 | 3 | 4 | 5 | 6 | 7 | 8 | 9 | 10 | 11 | 12 |
| Polyvalent | Mg sulfate | 2 | | | | | | | | | | 2 | 2 |
| metal salt | Mg acetate | | 3 | | | | | | 3 | | | | |
| | Ca carbonate | | | 4 | | | | | | 3 | | | |
| | Ca nitrate | | | | 4 | | | | | | 3 | | |
| | Ca acetate | | | | | 5 | | | | | | | |
| | Al silicate | | | | | | 3 | | | | | | |
| | Al hydroxide | | | | | | | 3 | | | | | |
| Surfactant | EMULGEN LS-106 | 0.5 | | | | | | | | | | 0.5 | 0.5 |
| | BYK-333 | | 0.5 | | | | | | | | | | |
| | TEGO-wet-270 | | | 0.5 | | | | | | 1 | 1 | | |
| | TEGO-wet-280 | | | | | 0.5 | | | | | | | |
| | Surfynol 420 | | | | 0.5 | | | | | | | | |
| | Surfynol PSA-336 | | | | | | 1 | | | | | | |
| | Surfynol 440 | | | | | | | 1 | | | | | |
| | FS-300 | | | | | | | | 0.5 | | | | |
| Acrylic resin | Resin Particle | 8.6 | 28.6 | 14.3 | 7.1 | | | | | | | 8.6 | 5.7 |
| | Dispersion Liquid 1 | | | | | | | | | | | | |
| | Dv: 200 nm, SC: 35% | | | | | | | | | | | | |
| | Resin Particle | | | | | 14.3 | | | | | | | |
| | Dispersion Liquid 2 | | | | | | | | | | | | |
| | Dv: 100 nm, SC: 35% | | | | | | | | | | | | |
| | Resin Particle | | | | | | 14.3 | | | | | | |
| | Dispersion Liquid 3 | | | | | | | | | | | | |
| | Dv: 300 nm, SC: 35% | | | | | | | | | | | | |
| | Resin Particle | | | | | | | | | 14.3 | | | |
| | Dispersion Liquid 4 | | | | | | | | | | | | |
| | Dv: 70 nm, SC: 35% | | | | | | | | | | | | |
| | Resin Particle | | | | | | | | | | 14.3 | | |
| | Dispersion Liquid 5 | | | | | | | | | | | | |
| | Dv: 350 nm, SC: 35% | | | | | | | | | | | | |
| | VINYLAN 1225 | | | | | | | 11.1 | | | | | |
| | Dv: 250 nm, SC: 45% | | | | | | | | | | | | |
| | VINYLAN 1245L | | | | | | | | 12.5 | | | | |
| | Dv: 250 nm, SC: 40% | | | | | | | | | | | | |
| Organic | 1,2-propanediol | 20 | 15 | 20 | | | | 10 | 5 | 10 | 15 | 20 | 20 |
| solvent | 1,3-butanedio1 | | 15 | | 20 | 10 | 15 | | 5 | | | | |
| | Ethylene glycol | 10 | | | 5 | 10 | | | | 5 | 8 | 10 | 10 |
| | moonobutyl ether | | | | | | | | | | | | |
| | 3-methoxy-3- | | | 10 | 5 | | 10 | 15 | 10 | 5 | | | |
| | methyl-1-butanol | | | | | | | | | | | | |
| Dye | Blue No. 1 | | | | | | | | | | | 0.1 | |
| Antibacterial | PROXEL LV | 0.1 | 0.1 | 0.1 | 0.1 | 0.1 | 0.1 | 0.1 | 0.1 | 0.1 | 0.1 | 0.1 | 0.1 |
| agent | | | | | | | | | | | | | |
| Water | Ion-exchanged | BL | BL | BL | BL | BL | BL | BL | BL | BL | BL | BL | BL |
| | water | | | | | | | | | | | | |

| | | | | | | | | | | | | |
|---|---|---|---|---|---|---|---|---|---|---|---|---|
| Amount (mass %) of nonionic acrylic | 3 | 10 | 5 | 2.5 | 5 | 5 | 5 | 5 | 5 | 5 | 3 | 2 |
| resin particles | | | | | | | | | | | | |
| Reflectance (%) at 400-700 nm | 95 | 85 | 93 | 96 | 92 | 89 | 88 | 86 | 88 | 93 | 72 | 91 |

In Table 1, Dv refers to Volume average particle diameter, SC refers to Resin particle solid content, and BL refers to balance.

TABLE 2

| | | Processing fluid | | | | |
|---|---|---|---|---|---|---|
| | | 13 | 14 | 15 | 16 | 17 |
| Polyvalent | Mg sulfate | 2 | | 2 | 2 | 3 |
| metal salt | Mg acetate | | | | | |
| | Ca carbonate | | | | | |
| | Ca nitrate | | | | | |
| | Ca acetate | | | | | |
| | Al silicate | | | | | |
| | Al hydroxide | | | | | |
| Surfactant | EMULGEN LS-106 | 0.5 | 0.5 | 0.5 | 0.5 | 1 |
| | BYK-333 | | | | | |
| | TEGO-wet-270 | | | | | |
| | TEGO-wet-280 | | | | | |
| | Surfynol 420 | | | | | |
| | Surfynol PSA-336 | | | | | |
| | Surfynol 440 | | | | | |
| | FS-300 | | | | | |
| Acrylic resin | Resin Particle | 14.3 | 14.3 | | | |
| | Dispersion Liquid 1 | | | | | |
| | Dv: 200 nm, SC: 35% | | | | | |
| | Resin Particle | | | | | |
| | Dispersion Liquid 2 | | | | | |
| | Dv: 100 nm, SC: 35% | | | | | |
| | Resin Particle | | | | | |
| | Dispersion Liquid 3 | | | | | |
| | Dv: 300 nm, SC: 35% | | | | | |
| | Resin Particle | | | | | |
| | Dispersion Liquid 4 | | | | | |
| | Dv: 70 nm, SC: 35% | | | | | |
| | Resin Particle | | | | | 42.9 |
| | Dispersion Liquid 5 | | | | | |
| | Dv: 350 nm, SC: 35% | | | | | |
| | SAIVINOL SK-200 | | | 11.1 | | |
| | Anionic acrylic resin | | | | | |
| | particles | | | | | |
| | Dv: 180 nm, SC: 45% | | | | | |
| | VINYLAN 2687 | | | | 16.7 | |
| | Cationic acrylic resin | | | | | |
| | particles | | | | | |
| | Dv: 200 nm, SC: 30% | | | | | |
| Organic | 1,2-propanediol | 20 | 20 | 20 | 20 | 20 |
| solvent | 1,3-butanediol | | | | | |
| | Ethylene glycol | 10 | 10 | 10 | 10 | 10 |
| | moonobutyl ether | | | | | |
| | 3-methoxy-3-methyl-1- | | | | | |
| | butanol | | | | | |
| Dye | Blue No. 1 | 0.05 | | | | |
| Antibacterial | PROXEL LV | 0.1 | 0.1 | 0.1 | 0.1 | 0.1 |
| agent | | | | | | |
| Water | Ion-exchanged water | balance | balance | balance | balance | balance |

| | | | | | |
|---|---|---|---|---|---|
| Amount (mass %) of nonionic acrylic | 5 | 5 | 0 | 0 | 15 |
| resin particles | | | | | |
| Reflectance (%) at 400-700 nm | 95 | 95 | 92 | 91 | 65 |

The details of the components presented in Tables 1 and 2 are as follows.

### -Polyvalent Metal Salt-

Magnesium sulfate (Mg sulfate), available from NACALAI TESQUE, INC.
Magnesium acetate (Mg acetate), available from NACALAI TESQUE, INC.
Calcium carbonate (Ca carbonate), available from NACALAI TESQUE, INC.
Calcium nitrate (Ca nitrate), available from NACALAI TESQUE, INC.
Calcium acetate (Ca acetate), available from NACALAI TESQUE, INC.
Aluminum silicate (Al silicate), available from NICHIAS Corporation
Aluminium hydroxide (Al hydroxide), available from TOMOE ENGINEERING CO., LTD.

### -Surfactant-

Polyoxyalkylene alkyl ether: EMULGEN LS-106, available from Kao Corporation
Silicone-based surfactant: BYK-333, available from TETSUTANI & CO., LTD.
Siloxane surfactant: TEGO-WET-270, available from Evonik Industries AG
Siloxane surfactant: TEGO-WET-280, available from Evonik Industries AG
Acetylene glycol surfactant: SURFYNOL 420, available from Nissin Chemical Industry Co., Ltd.
Acetylene glycol surfactant: SURFYNOL PSA336, available from Nissin Chemical Industry Co., Ltd.
Acetylene glycol surfactant: SURFYNOL 440, available from Nissin Chemical Industry Co., Ltd.
Fluorine-based surfactant: FS-300, available from Sigma-Aldrich Co., LLC

### -Acrylic Resin-

Nonionic acrylic resin particles: VINYLAN 1225, available from Nissin Chemical Industry Co., Ltd.
Nonionic acrylic resin particles: VINYLAN 1245L, available from Nissin Chemical Industry Co., Ltd.
Anionic acrylic resin particles: SAIVINOL SK-200, available from SAIDEN CHEMICAL INDUSTRY CO., LTD.
Cationic acrylic resin particles: VINYLAN 2687, available from Nissin Chemical Industry Co., Ltd.

### -Organic Solvent-

### 1,2-Propanediol

### 1,3-Butanediol

Ethylene glycol monobutyl ether
3-Methoxy-3-monomethyl-1-butanol

### -Dye-

Blue No. 1, available from Asako Koryo Kagaku, K.K.

### -Antibacterial Agent-

PROXEL LV, available from Lonza

### <Pigment Dispersion Liquid Preparation Example 1>

### <<Preparation of Black Pigment Dispersion>>

After premixing the materials of the following composition, the resulting mixture was circulated and dispersed by means of a disk-type bead mill (KDL, available from SHINMARU ENTERPRISES CORPORATION, media: zirconia balls each having a diameter of 0.3 mm) for 7 hours, to thereby obtain a black pigment dispersion (pigment solid content: 15% by mass).

Carbon black pigment (product name: Monarch800, available from Cabot Corporation): 15 parts by mass
Acryl-based polymer dispersant (Disperbyk-2010, available from BYK-Chemie GmbH): 5 parts by mass

### Ion-Exchanged Water: 80 Parts by Mass

### <Pigment Dispersion Liquid Preparation Example 2>

### <<Preparation of Cyan Pigment Dispersion>>

A cyan pigment dispersion liquid (pigment solid content: 15% by mass) was obtained in the same manner as in Pigment Dispersion Liquid Preparation Example 1, except that the carbon black pigment was replaced with Pigment Blue 15:3.

### <Pigment Dispersion Liquid Preparation Example 3>

### <<Preparation of Magenta Pigment Dispersion>>

A magenta pigment dispersion liquid (pigment solid content: 15% by mass) was obtained in the same manner as in Pigment Dispersion Liquid Preparation Example 1, except that the carbon black pigment was replaced with Pigment Red 269.

### <Pigment Dispersion Liquid Preparation Example 4>

### <<Preparation of Yellow Pigment Dispersion>>

A yellow pigment dispersion liquid (pigment solid content: 15% by mass) was obtained in the same manner as in Pigment Dispersion Liquid Preparation Example 1, except that the carbon black pigment was replaced with Pigment Yellow 74.

### [Preparation of Ink 1]

The materials of the following composition were blended and stirred, and the resultant mixture was filtered through a polypropylene filter having the average pore diameter of 0.8 μm to thereby prepare Ink 1.

Black pigment dispersion: 20 parts by mass
SURFYNOL 420 (nonionic surfactant, available from Evonik): 0.5 parts by mass
Superflex 210 (available from DKS Co., Ltd.): 6 parts by mass
PROXEL LV (antiseptic agent, available from Avecia): 0.1 parts by mass
1, 2-Propanediol: 15 parts by mass
Ethylene glycol monobutyl ether: 10 parts by mass
Ion-exchanged water: 48.4 parts by mass

### [Preparation of Inks 2 to 9]

Inks 2 to 9 were prepared according to the compositions presented in Table 3. The unit of the numeral values in Table 3 is % by mass.

TABLE 3

| | | Ink | | | | | | | | |
|---|---|---|---|---|---|---|---|---|---|---|
| | | 1 | 2 | 3 | 4 | 5 | 6 | 7 | 8 | 9 |
| Pigment dispersion | Black pigment | 20 | | | | | | 20 | 20 | 20 |
| | dispersion | | | | | | | | | |
| | Cyan pigment | | 20 | | | | | | | |
| | dispersion | | | | | | | | | |
| | Magenta | | | 20 | | 20 | | | | |
| | pigment | | | | | | | | | |
| | dispersion | | | | | | | | | |
| | Yellow pigment | | | | 20 | | 20 | | | |
| | dispersion | | | | | | | | | |
| Surfactant | SURFYNOL 420 | 0.5 | | | | | | | | |
| | SURFYNOL PSA-336 | | 0.5 | | | | 0.5 | | | |
| | SURFYNOL 440 | | | 0.5 | | | | | | |
| | SURFYNOL 465 | | | | 0.5 | | | | | |
| | SURFYNOL 485 | | | | | | | 0.5 | | |
| | TEGO Wet 270 | | | | | | | | 0.5 | |
| | FS-300 | | | | | 0.5 | | | | 0.5 |
| Binder resin | Superflex 210 | 6 | | | | | | | | 6 |
| | Boncoat | | 5 | | | 6 | | | 6 | |
| | CF-6140 | | | | | | | | | |
| | VINYLAN 2685 | | | 7 | | | 4 | | | |
| | VINYLAN 735 | | | | 8 | | | 3 | | |
| | Elitel KA-5034 | | | | | | | | | |
| Organic solvent | 1,2-propanediol | 15 | | | | | | | 20 | 15 |
| | 1,3-butanediol | | | | 15 | 13 | | 20 | | |
| | 1,3-propanediol | | 15 | | | | 12 | | | 5 |
| | Glycerin | | | 15 | 5 | | 14 | | | |
| | Ethylene glycol | 10 | | | | 13 | | | 7 | |
| | monobutyl ether | | | | | | | | | |
| | 3-methoxy-3- | | 10 | | 5 | | | | | 10 |
| | methyl-1-butanol | | | | | | | | | |
| | Dipropylene | | | 10 | | | | 7 | | |
| | glycol mono | | | | | | | | | |
| | methyl ether | | | | | | | | | |
| Anti- | PROXEL LV | 0.1 | 0.1 | 0.1 | 0.1 | 0.1 | 0.1 | 0.1 | 0.1 | 0.1 |
| bacterial agent | | | | | | | | | | |
| Water | Ion-exchanged | BL | BL | BL | BL | BL | BL | BL | BL | BL |
| | water | | | | | | | | | |

In Table 3, BL refers to balance.

The details of the components in Table 3 are as follows.

### -Surfactant-

Acetylene glycol surfactant: SURFYNOL 420, available from Nissin Chemical Industry Co., Ltd.
Acetylene glycol surfactant: SURFYNOL PSA336, available from Nissin Chemical Industry Co., Ltd.
Acetylene glycol surfactant: SURFYNOL 440, available from Nissin Chemical Industry Co., Ltd.
Acetylene glycol surfactant: SURFYNOL 465, available from Nissin Chemical Industry Co., Ltd.
Acetylene glycol surfactant: SURFYNOL 485, available from Nissin Chemical Industry Co., Ltd.
Siloxane surfactant: TEGO-WET-270, available from Evonik Industries AG
Fluorine-based surfactant: FS-300, available from Sigma-Aldrich Co., LLC

### -Binder Resin-

Urethane resin: Superflex 210 (available from DKS Co., Ltd.)
Acrylic resin: Boncoat CF-6140 (available from DIC Corporation)
Styrene acrylic resin: VINYLAN 2685 (available from Nissin Chemical Industry Co., Ltd.)
Vinyl chloride resin: VINYLAN 735 (available from Nissin Chemical Industry Co., Ltd.)
Polyester resin: Elitel KA-5034 (available from UNITIKA LTD.)

### -Organic Solvent-

### 1,2-Propanediol

### 1,3-Butanediol

### 1,3-Propanediol

### Glycerin

Ethylene glycol monobutyl ether
3-Methoxy-3-monomethyl-1-butanol
Dipropylene glycol monomethyl ether

### -Antibacterial Agent-

PROXEL LV, available from Lonza

Next, each of the obtained processing fluids and each of the obtained inks were used to evaluate “storage stability,” “discharge stability,” “abrasion resistance,” and “blur image” in the following manner. The results are presented in Tables 4 to 6.

### <Evaluation of Storage Stability of Processing Fluid>

The prepared processing fluid was placed in a sealed container, and left to stand in a thermostat chamber of 60° C. for 1 week. The storage stability of the processing fluid was evaluated from the viscosity change before and after the storage based on the following evaluation criteria. The results of A and B were determined as being acceptable.

### [Evaluation Criteria]

A: The viscosity change rate was 5% or less.
B: The viscosity change rate was greater than 5% but 10% or less.
C: The viscosity change rate was greater than 10% but 20% or less.
D: The viscosity change rate was greater than 20%, or aggregates were generated.

### <Evaluation of Discharge Stability of Processing Fluid>

An inkjet printer (device name: IPSIO GXe5500 (modified device), available from Ricoh Company Limited) was loaded with the prepared processing fluid. After decapping, discharge stability was evaluated.

First, head cleaning was performed by the maintenance command of the printer in the environment of 25° C., 30% RH, then a test chart was printed to confirm that all channels of the nozzles were in the dischargeable state.

Next, the inkjet printer was left to stand for 5 minutes with removing the cap of the head. Thereafter, a test chart was printed. Comparing the test charts printed before and after the standing, the number of the channels from which the processing fluid was not discharged (i.e., undischarging channels) was counted, and judged based on the following criteria. The result that the number of the undischarging channels was less than 10 (evaluation results of A and B) was determined as being suitable for practical use.

### [Evaluation Criteria]

A: The number of the undischarging channels was 1 or less.
B: The number of the undischarging channels was 2 or more but less than 10.
C: The number of the undischarging channels was 10 or more.

### <Evaluation of Abrasion Resistance>

The prepared processing fluid was applied onto a coat white ball JET STAR (basis weight: 270 g/m², available from NIPPON PAPER INDUSTRIES CO., LTD.) by inkjet printing by means of IPSIO GXe5500 available from Ricoh Company Limited, or bar coating by means of a bar coater to give the deposition amount (g/m²) presented in Tables 3 to 5. Thereafter, the applied processing fluid was dried at 70° C. for 2 minutes.

Another IPSIO GXe5500 available from Ricoh Company Limited was loaded with the prepared ink, and a solid image of the ink was printed on the dried base. The applied ink was dried at 70° C. for 2 minutes.

The solid image was rubbed with a 6 cm²-cut piece of dry cotton (Shirtings No. 3) in 100 returns with applying load of 400 g, and abrasion resistance was visually evaluated based on the following criteria The evaluation results of A and B were determined as being acceptable.

### [Evaluation Criteria]

A: The image density did not change even after rubbing 100 times or more.
B: Slight scratches were left after rubbing 100 times, but it did not affect the image density.
C: The image density reduced in the process of rubbing 100 times.
D: The image density reduced by rubbing 50 times or less.

### <Evaluation of Blur Image (Illegible Negative Lettering)>

The prepared processing fluid was applied onto a coat white ball JET STAR (basis weight: 270 g/m², available from NIPPON PAPER INDUSTRIES CO., LTD.) by inkjet printing by means of IPSIO GXe5500 available from Ricoh Company Limited, or bar coating by means of a bar coater to give the deposition amount (g/m²) presented in Tables 3 to 5. Thereafter, the applied processing fluid was dried at 70° C. for 2 minutes.

Another IPSIO GXe5500 available from Ricoh Company Limited was loaded with the prepared ink, and a chart of gothic-font outlined letters was printed on the dried base. The applied ink was dried at 70° C. for 2 minutes.

The readability of the letters of the obtained image was visually judged, and evaluated based on the following evaluation criteria. The evaluation results of A and B were determined as being acceptable.

### [Evaluation Criteria]

A: The letters of 3 pt gothic font were readable.
B: The letters of 3 pt were not readable, but the letters of 4 pt were readable.
C: The letters of 4 pt were not readable, but the letters of 5 pt were readable.
D: The letters of 5 pt were not readable.

TABLE 4

| | | Example | | | | | | |
|---|---|---|---|---|---|---|---|---|
| | | 1 | 2 | 3 | 4 | 5 | 6 | 7 |
| Combination | Processing Fluid | 1 | 2 | 3 | 4 | 3 | 3 | 7 |
| of fluids | Ink | 1 | 2 | 3 | 4 | 3 | 3 | 5 |
| Printing | processing fluid | IJ | IJ | IJ | IJ | IJ | roller | IJ |
| method | application | | | | | | | |
| | method | | | | | | | |
| | processing fluid | 10 | 10 | 10 | 10 | 10 | 10 | 1 |
| | deposition | | | | | | | |
| | amount (g/m²) | | | | | | | |
| | drying method | IR drying | IR drying | IR drying | IR drying | Hot air | IR drying | IR drying |
| | | | | | | drying | | |
| Evaluation | storage stability | A | B | A | A | A | A | A |
| results | discharge | A | B | A | A | A | — | A |
| | stability | | | | | | | |
| | abrasion | B | A | A | B | B | A | B |
| | resistance | | | | | | | |
| | image blurring | A | A | A | A | A | B | B |

TABLE 5

| | | Example | | | | | | |
|---|---|---|---|---|---|---|---|---|
| | | 8 | 9 | 10 | 11 | 12 | 13 | 14 |
| Combination | Processing Fluid | 8 | 3 | 3 | 5 | 6 | 13 | 11 |
| of fluids | Ink | 6 | 7 | 8 | 9 | 1 | 1 | 1 |
| Printing | processing fluid | IJ | IJ | IJ | IJ | IJ | IJ | IJ |
| method | application | | | | | | | |
| | method | | | | | | | |
| | processing fluid | 22 | 3 | 20 | 10 | 10 | 10 | 10 |
| | deposition | | | | | | | |
| | amount (g/m²) | | | | | | | |
| | drying method | IR drying | IR drying | IR drying | IR drying | IR drying | IR drying | IR drying |
| Evaluation | storage stability | A | A | A | A | A | B | B |
| results | discharge | A | A | A | A | A | B | B |
| | stability | | | | | | | |
| | abrasion | B | A | A | A | A | A | B |
| | resistance | | | | | | | |
| | image blurring | B | A | A | A | A | B | B |

TABLE 6

| | | Comparative Example | | | | | | |
|---|---|---|---|---|---|---|---|---|
| | | 1 | 2 | 3 | 4 | 5 | 6 | 7 |
| Combination | Processing Fluid | 9 | 10 | 12 | 14 | 15 | 16 | 17 |
| of fluids | Ink | 1 | 1 | 1 | 1 | 1 | 1 | 1 |
| Printing | processing fluid | IJ | IJ | IJ | IJ | IJ | IJ | IJ |
| method | application | | | | | | | |
| | method | | | | | | | |
| | processing fluid | 10 | 10 | 10 | 10 | 10 | 10 | 10 |
| | deposition | | | | | | | |
| | amount (g/m²) | | | | | | | |
| | drying method | IR drying | IR drying | IR drying | IR drying | IR drying | IR drying | IR drying |
| Evaluation | storage stability | D | D | A | A | D | C | C |
| results | discharge | B | C | A | A | D | C | D |
| | stability | | | | | | | |
| | abrasion | D | D | C | C | B | B | B |
| | resistance | | | | | | | |
| | image blurring | B | A | A | D | B | B | A |

Aspects and embodiments of the present disclosure are as follows, for example.

<1> A processing fluid including:

nonionic acrylic resin particles having a volume average particle diameter of 100 nm or greater but 300 nm or less; and

a polyvalent metal salt,

wherein a proportion of the nonionic acrylic resin particles is greater than 2.0% by mass, and

wherein an average reflectance of the processing fluid to light having a wavelength of 400 nm or greater but 700 nm or less is 70% or greater.

<2> The processing fluid according to <1>,

wherein a proportion of the nonionic acrylic resin particles in the processing fluid is 3% by mass or greater but 10% by mass or less.

<3> The processing fluid according to <1> or <2>, further including

a coloring material,

wherein a proportion of the coloring material in the processing fluid is less than 0.1% by mass.

<4> A method of producing printed matter, the method including:

applying the processing fluid according to any one of <1> to <3> onto a base;

applying an ink including a coloring material onto the base; and

drying the base onto which the ink has been applied.

<5> The method according to <4>,

wherein the applying the ink includes applying the ink onto the base by an inkjet system.

<6> The method according to <4> or <5>,

wherein the applying the processing fluid includes applying the processing fluid onto the base by an inkjet system.

<7> The method according to any one of <4> to <6>,

wherein an amount of the processing fluid applied onto the base is 3 g/m² or greater but 20 g/m² or less.

<8> The method according to any one of <4> to <7>, wherein the drying is infrared (IR) drying.

<9> A device of producing printed matter, the device including:

a processing fluid applying unit configured to apply the processing fluid according to any one of <1> to <3> onto a base;

an ink applying unit configured to apply an ink including a coloring material onto the base; and

a drying unit configured to dry the base onto which the ink has been applied.

The processing fluid according to any one of <1> to <3>, the production method of printed matter according to any one of <4> to <8>, and the production device of printed matter according to <9> can solve the various problems existing in the art and can achieve the object of the present disclosure.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A processing fluid comprising:
nonionic acrylic resin particles having a volume average particle diameter of 100 nm or greater but 300 nm or less; and
a polyvalent metal salt,
wherein a proportion of the nonionic acrylic resin particles in the processing fluid is greater than 2.0% by mass, and
wherein an average reflectance of the processing fluid to light having a wavelength of 400 nm or greater but 700 nm or less is 70% or greater.

2. The processing fluid according to claim 1,
wherein the proportion of the nonionic acrylic resin particles in the processing fluid is 3% by mass or greater but 10% by mass or less.

3. The processing fluid according to claim 1, further comprising
a coloring material,
wherein a proportion of the coloring material in the processing fluid is less than 0.1% by mass.

4. A method of producing printed matter, the method comprising:
applying the processing fluid according to claim 1 onto a base;
applying an ink including a coloring material onto the base; and
drying the base onto which the ink has been applied.

5. The method according to claim 4,
wherein the applying the ink includes applying the ink onto the base by an inkjet system.

6. The method according to claim 4,
wherein the applying the processing fluid includes applying the processing fluid onto the base by an inkjet system.

7. The method according to claim 4,
wherein an amount of the processing fluid applied onto the base is 3 g/m² or greater but 20 g/m² or less.

8. The method according to claim 4,
wherein the drying is infrared (IR) drying.

9. A device of producing printed matter, the device comprising:
a processing fluid applying unit configured to apply the processing fluid according to claim 1 onto a base;
an ink applying unit configured to apply an ink including a coloring material onto the base; and
a drying unit configured to dry the base onto which the ink has been applied.
